(19) United States
(12) Patent Application Publication
(10) Pub. No.: US 2017/0056932 A1
(43) Pub. Date: Mar. 2, 2017

(54) DETECTION DEVICE CLEANING APPARATUS HAVING FAN

(71) Applicant: DENSO CORPORATION, Kariya-city (JP)

(72) Inventor: Masaya TANAKA, Ann Arbor, MI (US)

(21) Appl. No.: 14/836,217

(22) Filed: Aug. 26, 2015

(51) Int. Cl. B08B 1/00

(52) U.S. Cl. CPC B08B 1/006

(57) ABSTRACT

A housing device has an aperture, which is a through hole. A shield is non-opaque. The shield is rotational in the housing device and is opposed to the aperture. A wiper blade is equipped to the aperture and is directed toward the shield. A fan has fins configured to receive hydraulic force to rotate the shield.

### TECHNICAL FIELD

The present disclosure relates to a detection device cleaning apparatus.

### BACKGROUND

Conventionally, a detection device may be installed on a vehicle for detecting an external condition of the vehicle. A detection device may be an imaging device such as a camera, a millimeter-wave radar, or a laser radar. Such a detection device may be exposed to the weather to result in deposition of debris. Consequently, such deposition of debris may degrade performance of the detection device. A detection device may be employed in an automated vehicle. In such a case, degradation of the detection device may exert adverse effect on a safety operation of the automated vehicle.

### SUMMARY

According to an aspect of the preset disclosure, a housing device may have an aperture being a through hole. A shield being non-opaque may be rotational in the housing device and may be opposed to the aperture. A wiper blade may be equipped to the aperture and may be directed toward the shield. A fan may have fins configured to receive hydraulic force to rotate the shield.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective exploded view showing components of a detection device cleaning apparatus;

FIG. 2 is a perspective view showing the detection device cleaning apparatus;

FIG. 3 is a sectional side view showing the detection device cleaning apparatus;

FIG. 4 is a perspective exploded view showing components of a detection device cleaning apparatus according to a second embodiment;

FIG. 5 is a perspective exploded view showing components of a detection device cleaning apparatus according to a third embodiment;

FIG. 6 is a perspective exploded view showing components of a detection device cleaning apparatus according to a fourth embodiment;

FIG. 7 is a perspective exploded view showing components of a detection device cleaning apparatus according to a fifth embodiment;

FIG. 8 is a perspective exploded view showing components of a detection device cleaning apparatus according to a seventh embodiment; and

FIG. 9 is a perspective exploded view showing components of a detection device cleaning apparatus according to an eighth embodiment.

### DETAILED DESCRIPTION

### First Embodiment

As follows, a first embodiment of the present disclosure will be described with reference to drawings. In the description, a vertical direction is along an arrow represented by “VERTICAL” in drawing(s). A lateral direction is along an arrow represented by “LATERAL” in drawing(s). An axial direction is along an arrow represented by “AXIAL” in drawing(s). A circumferential direction is along an arrow represented by “CIRCUMFERENTIAL” in drawing(s).

### First Embodiment

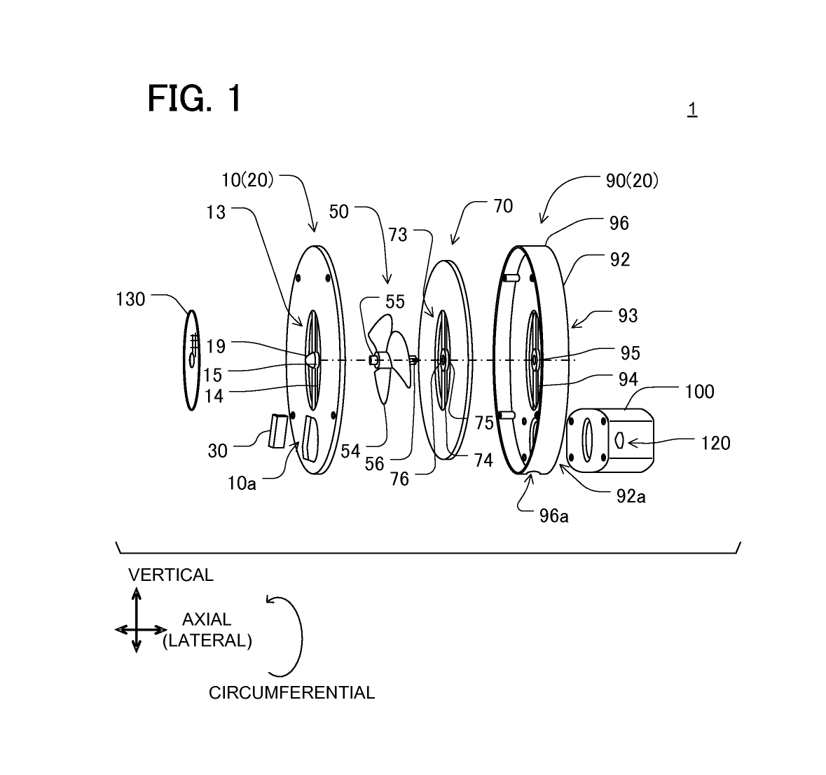

The first embodiment will be described with reference to FIGS. 1 to 3. A detection device system includes an imaging device 100 and a detection device cleaning apparatus 1, which is coupled with the imaging device 100. The imaging device system may be mounted on an exterior of a vehicle such as an automotive. The imaging device 100 may be one example of a detection device.

The imaging device 100 is, for example, a camera 100 having an electronic imaging element 120 such as a charge coupled device (CCD) accommodated in a case. The imaging device 100 may employ various configurations to detect moving picture and/or still picture in color. The imaging device 100 may be connected to an electronic control unit (ECU: not shown) of the vehicle to send detected images to the ECU. The imaging element 120 may be one example of a detection element.

The detection device cleaning apparatus 1 includes a panel 10, a fan 50, a shield 70, and a housing 90. The housing 90, the panel 10, and the fan 50 may be formed of a weather-resistive material. Specifically, the weather-resistive material may be metal such as aluminum and/or resin such as polycarbonate.

The housing 90 is a bottomed tubular member. The housing 90 has a bottom wall 92 in a circular shape and a sidewall 96 in an annular shape. The sidewall 96 may extend around the circumferential periphery of the bottom wall 92. The bottom wall 92 and the sidewall 96 may form an internal space. The sidewall 96 may have a drain hole 96a on the lower side in the vertical direction. The drain hole 96a may be a through hole extending through the sidewall 96 in the thickness direction of the sidewall 96. The bottom wall 92 may have a center portion defining a bottom opening 93, which is a through hole extending in the thickness direction of the bottom wall. The bottom wall 92 may have a bottom frame 94 and a bottom bearing 95 at the center portion. The bottom frame 94 may extend radially inward from the periphery of the bottom opening 93 to the bottom bearing 95 to support the bottom bearing 95. The bottom wall 92 has a bottom aperture 92a, which is a through hole extending through the bottom wall 92 in the thickness direction. The bottom aperture 92a may be offset from the center of the bottom wall 92 in the radial direction.

The panel 10 may be in a circular disc shape. The panel 10 may have a center portion defining a panel opening 13, which is a through hole extending in the thickness direction of the panel 10. The panel 10 may have a panel frame 14 and a panel bearing 15 at the center portion. The panel frame 14 may extend radially inward from the periphery of the panel opening 13 to the panel bearing 15 to support the panel bearing 15. The panel bearing 15 is equipped with a cone 19 protruding outward in the axial direction. The panel 10 and the housing 90 may be affixed together to form a housing device 20. The panel 10 has a panel aperture 10a, which is a through hole extending through the panel 10 in the thickness direction of the panel 10. The panel aperture 10a may be offset from the center of the panel 10.

A filer 130 in a disc shape may be attached to the panel opening 13 to capture debris. The filter may be, for example, a mesh formed of resin and/or metal such as a nonwoven fabric and/or a steel wire.

A wiper blade 30 is equipped to the panel aperture 10a of the panel 10. Specifically, the wiper blade 30 may be mounted to a part of a brim of the panel aperture 10a. The wiper blade 30 is positioned within the panel aperture 10a to extend through the panel aperture 10a in the axial direction. The wiper blade 30 may be formed of, for example, an elastic material such as rubber and/or fabric. In the present example, the wiper blade 30 is in a plate shape. The wiper blade 30 may be equipped with a brush end. The brush end may include, for example, multiple bristles to function as a scrubber and/or a sweeper.

The shield 70 may be in a disc shape or in a sheet shape. The shield 70 may be a non-opaque member formed of a light transmissive material such as glass and/or acrylic resin. The shield 70 may be transparent to allow light to pass therethrough. The shield 70 has a center portion defining a shield opening 73, which is a through hole extending in the thickness direction of the shield 70. The shield 70 may have a shield frame 74 and a shield center 75 at the center portion. The shield frame 74 may extend radially inward from the periphery of the shield opening 73 to the shield center 75 to support the shield center 75. The shield center 75 may have a through hole at the center. The shield center 75 may have a recess 76 dented from the inner periphery of the through hole radially outward.

The fan 50 has a fan axis 55 and multiple fins 54. The fins 54 may be extended from the fan axis 55 and are set at an angle relative to the fan axis 55. The fan 50 may be coaxial with the fan axis 55 and may be rotatable about the fan axis 55. The fan 50 is configured to receive hydraulic force to rotate about the fan axis 55. Specifically, the fin 54 may have a curved surface and may have a wing cross section effectively to receive hydraulic force along the fan axis 55 to convert the hydraulic energy into rotational energy. The hydraulic force may be caused by fluid such as gas and/or liquid. Specifically, the gas may be air flowing around the vehicle, and the liquid may be water such as rainfall. The fan axis 55 may have a mechanical key 56 protruded from the periphery of the fan axis 55 radially outward. The mechanical key 56 may be configured to be fitted to the recess 76 of the shield center 75 of the shield 70.

The panel 10, the fan 50, the shield 70, and the housing 90 are assembled into the detection device cleaning apparatus 1. Specifically, the fan 50 may be affixed coaxially to the shield 70 such that the mechanical key 56 of the fan axis 55 is fitted to the recess 76 of the shield center 75 of the shield 70. The fan 50 and the shield 70 may be affixed together such that the fan 50 and the shield 70 are not movable relative to each other. The fan 50 and the shield 70 may be further attached coaxially to the housing 90. Specifically, the end of the fan axis 55 may be fitted to the bottom bearing 95 such that the fan 50 and the shield 70 are rotationally supported by the housing 90. The panel 10 may be further affixed coaxially to the fan 50, the shield 70, and the housing 90. Specifically, the other end of the fan axis 55 may be fitted to the panel bearing 15 such that the fan 50 and the shield 70 are rotationally supported by the panel 10.

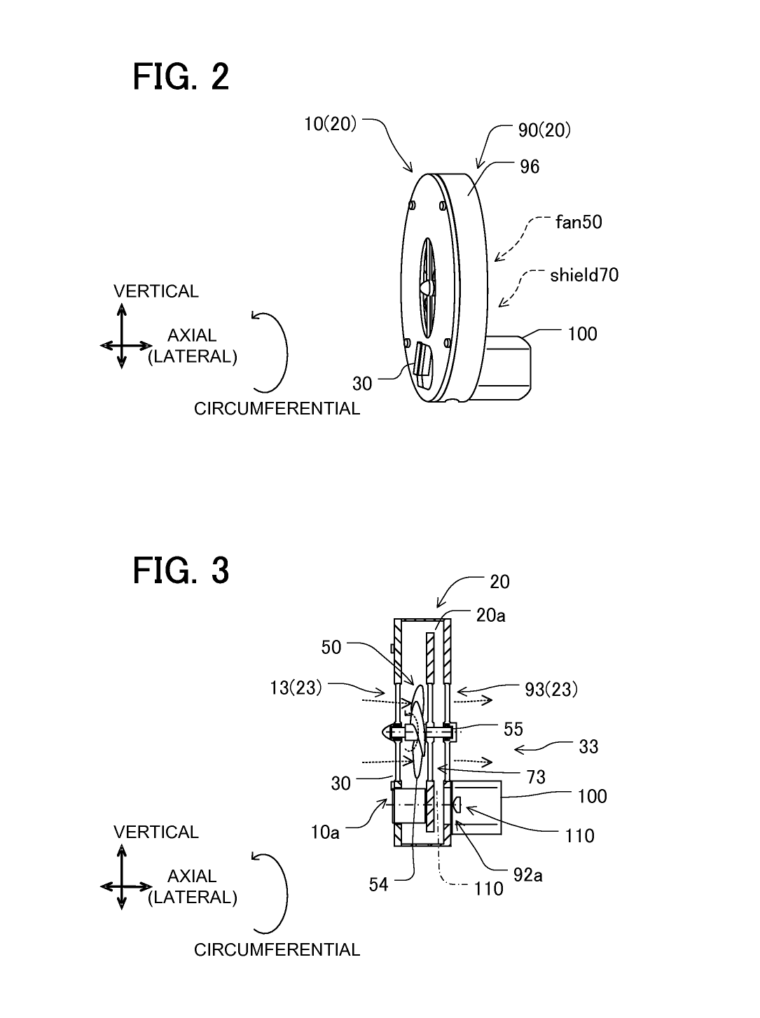

Thus, as shown in FIG. 2, the fan 50 and the shield 70, which are affixed together, are accommodated in the housing device 20. The panel 10 may be affixed to the sidewall 96 of the housing 90 with multiple fasteners such as screws.

As shown in FIG. 3, the fan 50 and the shield 70, which are affixed together, may be supported rotationally between the panel 10 and the housing 90 in an internal space 20a of the housing device 20. The wiper blade 30 may extend from the panel aperture 10a into the internal space 20a toward the shield 70. The wiper blade 30 has a tip end, which may be slightly in contact with the surface of the shield 70 or may slightly float on the surface of the shield 70. The wiper blade 30 may be in contact with the surface of the shield 70 at the brush equipped to the end of the wiper blade 30.

The panel opening 13, the shield opening 73, and the bottom opening 93 may be aligned along the axial direction of the fan axis 55 to form an air passage 33. The panel opening 13, the shield opening 73, and the bottom opening 93 may be opposed to each other and may be overlapped one another to form the air passage 33. The fins 54 of the fan 50 may be at least partially located in the air passage 33. The panel opening 13 and the bottom opening 93 may form a housing opening 23.

The panel 10 may be affixed to the housing 90 such that the panel aperture 10a and the bottom aperture 92a are aligned to be overlapped one another along the axial direction. Thus, the panel aperture 10a and the bottom aperture 92a may define an optical path 110 extending along the axial direction. The shield 70 may reside on the optical path 110. The optical path 110 may extend through the shield 70, which is a non-opaque object. The shield 70 covers the bottom aperture 92a to protect the bottom aperture 92a from foreign matters such as debris. Simultaneously, the shield 70 may permit light to pass along the optical path 110 through the panel aperture 10a, the shield 70, and the bottom aperture 92a. The optical path 110 may be one example of a detection path.

The camera 100 may be mounted to the bottom wall 92 of the housing 90 by using, for example, fasteners such as screws. The imaging element 120 of the camera 100 may be aligned with the optical path 110. Thus, the shield 70 may permit the camera 100 to conduct imaging along the optical path 110 through the shield 70, while protecting the camera 100 from foreign matters.

The detection device cleaning apparatus 1 may be mounted to the vehicle such that a front surface of the panel 10 is directed to the front of the vehicle. The device may be installed at various positions in the vehicle such as a front bumper, a front grill, a side mirror, an engine hood, and/or a roof, such that the vertical direction of the device is along the direction of gravity.

In FIG. 3, as shown by dotted arrows, as the vehicle travels, ram air may occur to pass by the vehicle and the detection device cleaning apparatus 1. Ram air may pass through the air passage 33 and may pass around the fan 50. In this example, ram air may cause hydraulic force applied onto the fins 54 of the fun 50 to rotate the fan 50 about the fan axis 55. In this way, the hydraulic force may be utilized to drive the shield 70 affixed to the fan 50. As the shield 70 rotates, the wiper blade 30 may abrade on the shield 70 and/or may abrade foreign matters deposited on the shield 70. Thus, the wiper blade 30 may sweep debris deposited on the shield 70, thereby to keep the shield 70 light-transmissive to enable the imaging element 120 of the camera 100 to acquire an image on the optical path 110 through the shield 70. The detection device cleaning apparatus 1 may utilize hydraulic force generated by fluid stream such as ram air and may not need electric power supply to drive the shield 70.

### Second Embodiment

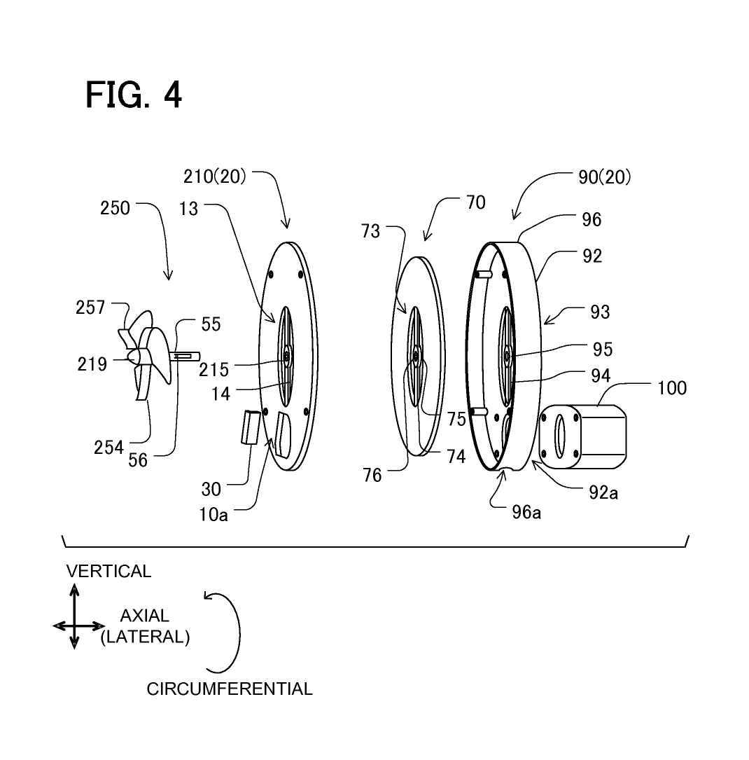

As shown in the example of FIG. 4, a fan 250 is out of the housing device 20. In the present example, the fan 250, a panel 210, the shield 70, and the housing 90 may be arranged in this order along the axial direction of the fan axis 55. The fan 250 may have a cone 219 at the center. The fan axis 55 may be assembled such that the fan axis 55 skewers a panel bearing 215 of the panel 10 and the shield 70. The end of the fan axis 55 is further stubbed into the bottom bearing 95 of the housing 90. Thus, the fan 250 and the shield 70, which are affixed to each other, may be rotationally supported by both the panel 210 and the housing 90. In the present example, each of fins (254) has a vane 257. The vane 257 may be in a strip-shape extended along a part of the periphery of the fin 254 and bend along the shape of the corresponding periphery of the fin 254. The vane 257 may be located at an upstream periphery of the fin 254. The vane 257 may extend linearly along the fan axis 55. The surface of the vane 257 may be perpendicular to the fan axis 55 and configured to receive hydraulic force perpendicular to the fan axis 55. In the present embodiment, the fan 250 located outside the housing device 20 may receive hydraulic force of ram air in the axial direction and hydraulic force of airstream such as side wind in both the lateral and vertical directions. The fan 250 with the vanes 257 may also receive hydraulic force of precipitation such as rain fall in the vertical direction.

### Third Embodiment

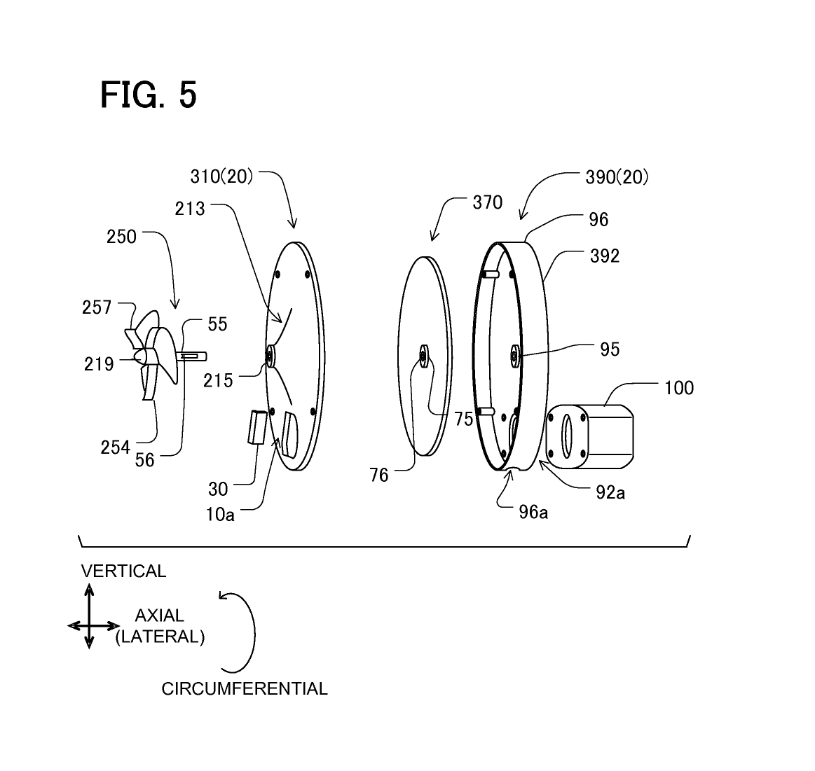

As shown in the example of FIG. 5, the fan 250 is out of the housing device 20. In the example, a plate 310 of the housing device 20 has a protruded surface 213 protruded toward a plate bearing 215 at the center of the plate 310. The protruded surface 213 is also protruded toward the fan 250 supported by the plate bearing 215. The protruded surface 213 may be a curved surface increasing in height gradually from the periphery of the panel 310 toward the center of the panel 310. The protruded surface 213 may be concaved at an intermediate portion. The protruded surface 213 may deflect fluidic stream such as ram air radially outward. In the example, the openings 13, 73, 93 described in the above embodiments may be omitted from the plate 310, a shield 370, and a bottom wall 392 of a housing 390, respectively.

### Fourth Embodiment

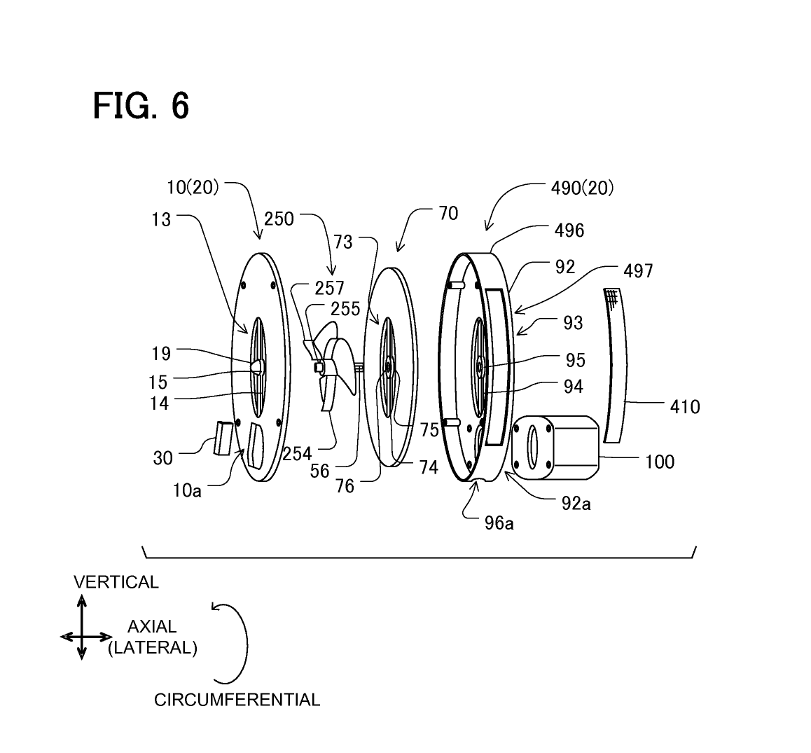

As shown in the example of FIG. 6, in the example, a sidewall 496 of a housing 490 has a lateral side opening 497. The lateral side opening 497 is a through hole extending through the sidewall 496 in the thickness direction. The lateral side opening 497 may be directed in the horizontal direction relative to the direction of the gravitational force when the housing device 20 is installed on the vehicle. The lateral side opening 497 may enable to pass airflow in the lateral direction therethough to enable the fins 254 and the vanes 257 of the fan 50 to receive the hydraulic force of the airflow.

A filer 410 in a strip shape may be attached to the lateral side opening 497 to capture debris. The filter may be, for example, a mesh formed of resin and/or metal such as a nonwoven fabric and/or a steel wire.

### Fifth Embodiment

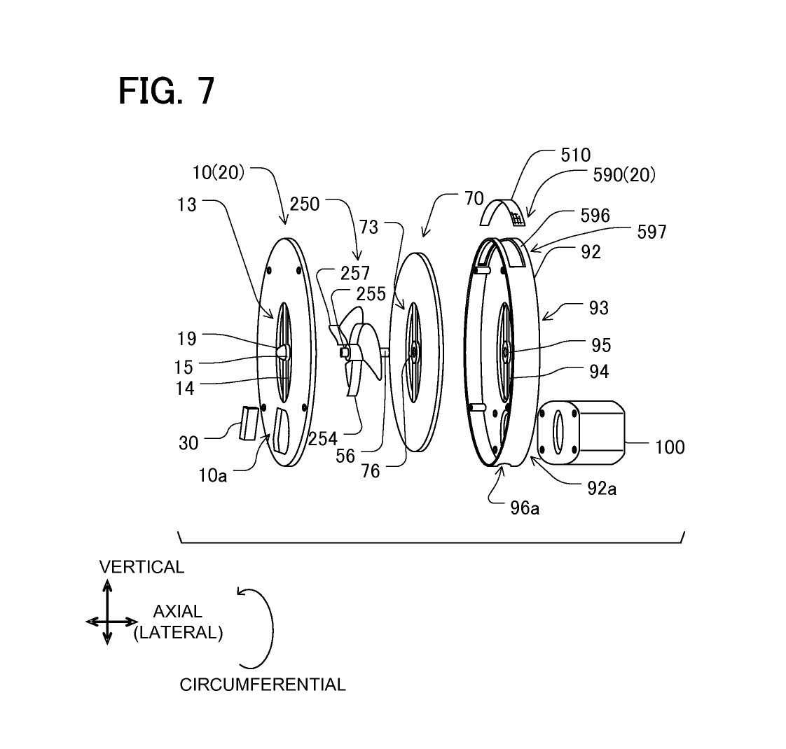

As shown in the example of FIG. 7, a sidewall 596 of a housing 590 has an upper side opening 597. The upper side opening 597 is a through hole extending through the sidewall 596 in the thickness direction. The upper side opening 597 may be directed in the upper direction relative to the direction of the gravitational force. The upper side opening 597 may enable to pass airflow and/or precipitation in the vertical direction therethough to enable the fins 254 and the vanes 257 of the fan 50 to receive the hydraulic force of the airflow and/or precipitation. The upper side opening 597 may enable, for example, rainfall to pass therethrough to cause water flow inside the housing 510. The water flow may be utilized to wash the shield 70 and/or to wash a part of the camera 100 exposed through the bottom aperture 92a of the bottom wall 92. The water may be drained through the drain hole 96a to the outside of the housing device 20.

A filer 510 in a strip shape may be attached to the upper side opening 597 to capture debris. The filter may be, for example, a mesh formed of resin and/or metal such as a nonwoven fabric and/or a steel wire.

### Sixth Embodiment

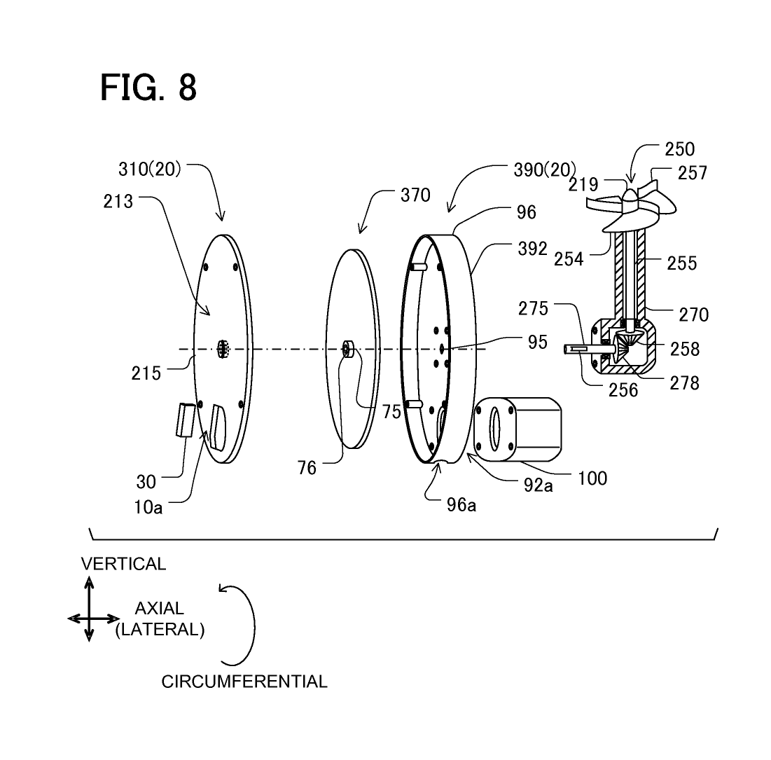

As shown in the example of FIG. 8, the fan 250 is outside the housing device 20 and is directed upward in the vertical direction. A fan axis 255 of the fan 250 is equipped with a bevel gear 258 at one end. A rotational axis 275 is equipped with a bevel gear 278 at one end. The bevel gear 278 is meshed with the bevel gear 258 of the fan axis 255. The fan axis 255, the bevel gear 258, the bevel gear 278, and a part the one end of the rotational axis 275 are accommodated in a casing 270. The other end of the rotational axis 275 is protruded from the casing 270. The fan axis 255 and the rotational axis 275 are rotationally supported by the casing 270 and are directed in different directions from each other. In the example, the fan axis 255 and the rotational axis 275 are directed perpendicularly to each other. The casing 270 may be affixed to a bottom wall 392 of the housing 90 by using, for example, fasteners such as screws. The rotational axis 275 may have a mechanical key 256 fitted to the recess 76 formed in the shield center 75 of the shield 70. Thus, the rotational axis 275 and the shield 70 may be affixed together and rotational integrally with each other. The rotational axis 275 may be rotationally supported by the panel bearing 15 at the other end. The panel bearing 15 may be closed on the front side.

The bevel gears 256 and 258 meshed together may be configured to convert rotation of the fan 250 into rotation of the rotational axis 275 in the perpendicular direction. The fan 250 may be totally exposed to the outside. The fan 250 may enable the fins (254) and the vanes 257 to receive the hydraulic force of the airflow and/or precipitation in various directions. In the example, the fan 250 may be enlarged to receive greater hydraulic force thereby to gain greater rotational torque in consideration of friction loss caused by the bevel gears 256 and 258 and the casing 270. The fan 250 may be accommodated in a housing.

### Seventh Embodiment

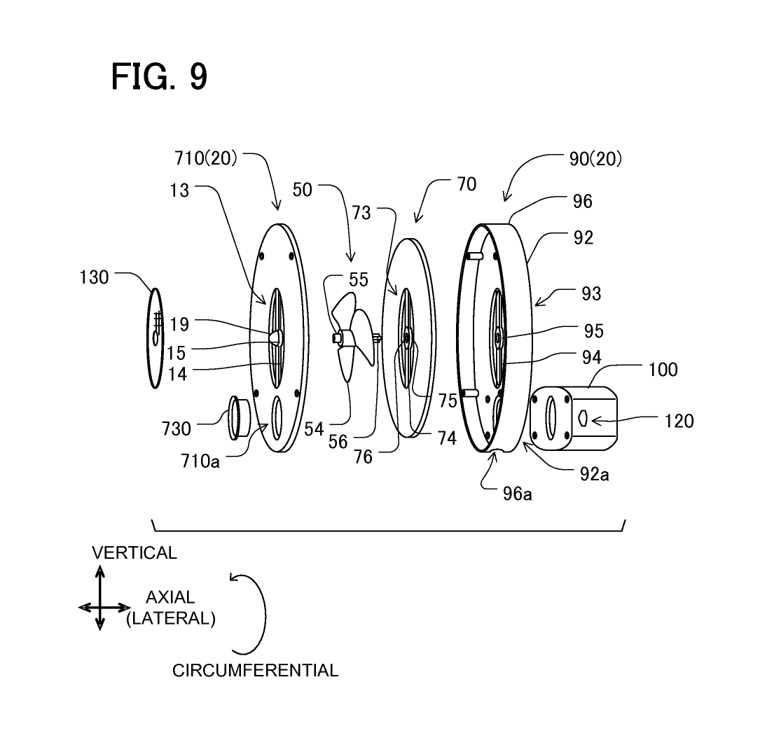

As shown in the example of FIG. 9, a wiper blade 730 is in a tubular shape. The wiper blade 730 is equipped to a brim of the panel aperture 710a and extended toward the shield 70. The wiper blade 730 may have a brush having a configuration similar to that of the first embodiment. The wiper blade 730 may be configured to clean the shield 70. In the example, the wiper blade 730 may surround the panel aperture 10a and may restrict debris from intruding into the internal space 20a of the housing device 20.

### Other Embodiment

The above-described configurations may be employed in various devices other than an imaging device. For example, the configurations may be employed in a millimeter-wave radar and/or a laser radar.

The lens may be applied with nano-coating to enhance cleaning effect.

The components described in the above-described embodiments may be arbitrarily combined and/or omitted. For example, the lateral side opening 497 in the fifth embodiment may be combined with the upper side opening 497 in the sixth embodiment.

The fan may be at the same position as the shield in the axial direction. The fan may be within the shield opening.

It should be appreciated that while the processes of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A detection device cleaning apparatus comprising:
a housing device having an aperture, which is a through hole;
a shield being non-opaque, the shield being rotational in the housing device and being opposed to the aperture;
a wiper blade equipped to the aperture and directed toward the shield; and
a fan having a plurality of fins configured to receive hydraulic force to rotate the shield.

2. The detection device cleaning apparatus of claim 1, wherein
the fan has a fan axis affixed to the shield and coaxial with the shield.

3. The detection device cleaning apparatus of claim 2, wherein
the fan is accommodated in the housing device.

4. The detection device cleaning apparatus of claim 2, wherein
the fan is out of the housing device.

5. The detection device cleaning apparatus of claim 4, wherein
the housing device has a protruded surface protruded toward the fan.

6. The detection device cleaning apparatus of claim 1, wherein
the fins are configured to receive hydraulic force along the fan axis, and
at least one of the fins has a vane configured to receive hydraulic force perpendicular to the fan axis.

7. The detection device cleaning apparatus of claim 3, wherein
the housing device has a sidewall, and
the sidewall has at least one side opening, which is a through hole extending through the sidewall in a thickness direction.

8. The detection device cleaning apparatus of claim 6, wherein
the side opening is directed in a horizontal direction relative to a direction of a gravitational force.

9. The detection device cleaning apparatus of claim 6, wherein
the side opening is directed in an upper direction relative to a direction of a gravitational force.

10. The detection device cleaning apparatus of claim 4, wherein
the fan has a fan axis about which the fan is rotational,
the shield is equipped with a rotational axis about which the shield is rotational, and
the fan axis and the rotational axis extend in different directions.

11. The detection device cleaning apparatus of claim 1, wherein
the wiper blade is in a plate shape equipped to one side of the aperture and extended toward the shield.

12. The detection device cleaning apparatus of claim 1, wherein
the wiper blade is in a tubular shape equipped to a brim of the aperture and extended toward the shield.

13. The detection device cleaning apparatus of claim 1, wherein
the housing device has a housing opening,
the shield has a shield opening,
the housing opening and the shield opening are opposed to each other and overlapped one another to form an air passage, and
the fan is at least partially located in the air passage.

14. The detection device cleaning apparatus of claim 1, wherein
the aperture of the housing device is configured to be equipped with a detection device,
the aperture defines a detection path aligned with a detection element of the detection device, and
the detection path extends through the shield.

15. The detection device cleaning apparatus of claim 1, wherein
the shield is in a disc shape,
the housing device includes a housing and a panel,
the housing is in a bottomed tubular shape,
the panel is in a plate shape,
the panel is affixed to the housing to form an internal space, and
the shield is accommodated in the internal space and is interposed between the housing and the panel.
